(19) United States
(12) Patent Application Publication
(10) Pub. No.: US 2018/0180222 A1
(43) Pub. Date: Jun. 28, 2018

(54) HIGH PRESSURE TANK, AND METHOD OF PRODUCING HIGH PRESSURE TANK

(71) Applicant: TOYOTA JIDOSHA KABUSHIKI KAISHA, Toyota-shi (JP)

(72) Inventors: Naoki UEDA, Toyota-shi (JP); Masayoshi TAKAMI, Hamamatsu-shi (JP); Koichiro HAYASHI, Toyota-shi (JP); Takashi INOH, Toyota-shi (JP)

(73) Assignee: TOYOTA JIDOSHA KABUSHIKI KAISHA, Toyota-shi (JP)

(21) Appl. No.: 15/843,529

(22) Filed: Dec. 15, 2017

(30) Foreign Application Priority Data
Dec. 22, 2016 (JP) 2016-248698

(51) Int. Cl. F17C 1/16

(52) U.S. Cl. CPC F17C 1/16; F17C 2221/012; F17C 2203/012; F17C 2203/0604; F17C 2203/0629; F17C 2270/0168; F17C 2270/0189; F17C 2270/0105; F17C 2209/2154; F17C 2203/066; F17C 2203/0643; F17C 2203/0673; F17C 2203/0668; F17C 2209/232; F17C 2201/0109

(57) ABSTRACT

A high pressure tank includes a liner, a reinforcing layer which includes a first thermosetting resin and fibers and is formed on the liner, and a protective layer which includes a second thermosetting resin having a lower gelling temperature than the a gelling temperature of first thermosetting resin and is formed on the reinforcing layer.

### INCORPORATION BY REFERENCE

The disclosure of Japanese Patent Application No. 2016-248698 filed on Dec. 22, 2016 including the specification, drawings and abstract is incorporated herein by reference in its entirety.

### BACKGROUND

### 1. Technical Field

The technology disclosed in this specification relates to a high pressure tank.

### 2. Description of Related Art

As a high pressure tank into which a fluid such as hydrogen gas is filled at a high pressure, a high pressure tank including a liner and an outer shell layer formed on a surface of the liner is known. As the outer shell layer, a structure including two carbon fiber reinforced epoxy resin layers and an epoxy resin layer has been proposed (for example, refer to Japanese Unexamined Patent Application Publication No 2010-038216 (JP 2010-038216 A).

### SUMMARY

When a fiber reinforced epoxy resin layer is formed, a gas may be contained in an epoxy resin before curing. When the epoxy resin is cured, if the viscosity of the epoxy resin decreases due to heating, the contained gas moves toward the surface, a convex part is formed in the surface of an outer shell layer due to air bubbles, and there is a possibility of the smoothness of the surface of the outer shell layer being impaired. Here, this possibility is not limited to a case in which an epoxy resin is used as a resin of the outer shell layer, but it is the same when various thermosetting resins are used.

In this specification, a technology for improving the smoothness of a surface of a high pressure tank is disclosed.

The technology disclosed in this specification can be realized as the following aspects.

(1) According to an aspect of the technology disclosed in this specification, there is provided a high pressure tank. The high pressure tank includes a liner, a reinforcing layer which includes a first thermosetting resin and fibers and is formed on the liner, and a protective layer which includes a second thermosetting resin having a lower gelling temperature than a gelling temperature of the first thermosetting resin and is formed on the reinforcing layer.

In the high pressure tank according to the aspect, since a gelling temperature of the second thermosetting resin that forms the protective layer is lower than a gelling temperature of the first thermosetting resin that forms the reinforcing layer, when the protective layer and the reinforcing layer are heated and cured at the same time, the protective layer becomes a gel earlier than the reinforcing layer. That is, when the viscosity of the first thermosetting resin that forms the reinforcing layer decreases and the first thermosetting resin has fluidity, since the second thermosetting resin that forms the protective layer has already gelled, movement of the first thermosetting resin and an inherent gas to the surface of the reinforcing layer is minimized. As a result, the smoothness of the surface of the high pressure tank is improved.

(2) In the high pressure tank according to the aspect, the protective layer may include fibers. Accordingly, it is possible to realize a high pressure tank with a higher strength.

Here, the technology disclosed in this specification can be realized in various forms. For example, it can be realized in the form such as a fuel cell system including a high pressure tank, a mobile system in which the fuel cell system is mounted, and a method of producing a high pressure tank.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a sectional view showing a schematic configuration of a high pressure tank that is an embodiment of the present technology;

FIG. 2 is a diagram showing temperature-viscosity characteristics of a first thermosetting resin and a second thermosetting resin;

FIG. 3 is a flowchart showing a method of producing a high pressure tank; and

FIG. 4 is an explanatory diagram conceptually showing changes of a temperature and a viscosity of resins over time in a high pressure tank of a comparative example.

### DETAILED DESCRIPTION OF EMBODIMENTS

### A. Embodiment: A1. Configuration of High Pressure Tank

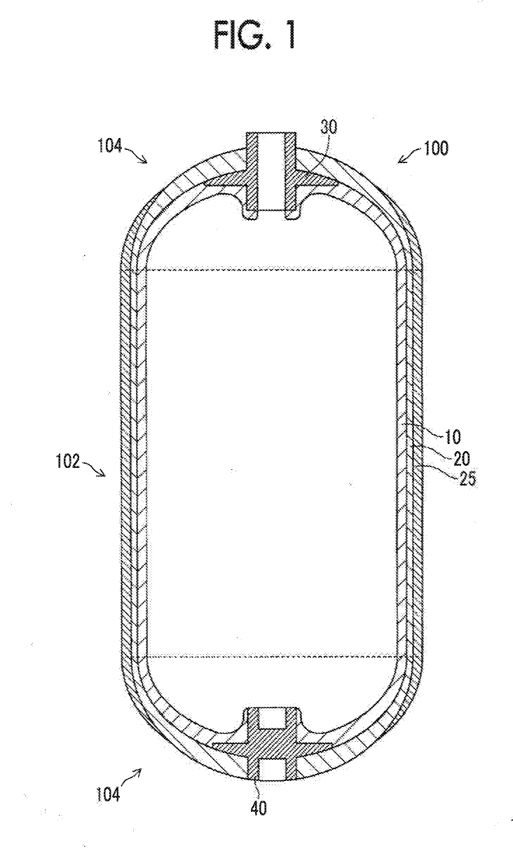

FIG. 1 is a sectional view showing a schematic configuration of a high pressure tank that is an embodiment of the present technology. In the present embodiment, for example, compressed hydrogen is filled into a high pressure tank 100. The high pressure tank 100 is mounted in a fuel cell vehicle, for example, in order to supply hydrogen to a fuel cell. Here, the high pressure tank 100 may be mounted in not only a fuel cell vehicle but also other vehicles such as an electric vehicle and a hybrid vehicle, and may be mounted in other mobile systems such as a ship, an airplane, and a robot. In addition, it may be provided in stationary facilities such as a house and a building.

The high pressure tank 100 is a hollow container including a cylindrical part 102 that has substantially a cylindrical shape and a dome part 104 that is integrally provided at both ends thereof and has a substantially a hemispherical shape. In FIG. 1, the boundary between the cylindrical part 102 and the dome part 104 is indicated by a dashed line. The high pressure tank 100 includes a liner 10, a reinforcing layer 20, a protective layer 25, a mouthpiece 30, and a mouthpiece 40. The liner 10 to which the mouthpiece 30 and the mouthpiece 40 are attached will be referred below to as a “tank main body.”

The liner 10 is made of a nylon resin and has a property (a so-called gas barrier property) of preventing hydrogen and the like filled into an internal space from leaking to the outside. The liner 10 may be made of other synthetic resins having a gas barrier property such as a polyethylene resin or a metal such as stainless steel.

The reinforcing layer 20 is formed to cover the outer surface of the tank main body. Specifically, the reinforcing layer 20 is formed to cover the entire outer surface of the liner 10 and parts of the mouthpieces 30 and 40. The reinforcing layer 20 is made of a carbon fiber reinforced resin (CFRP: carbon fiber reinforced plastics) which is a composite material of a first thermosetting resin and a carbon fiber and has a pressure resistance. In the present embodiment, an epoxy resin is used as the first thermosetting resin. The first thermosetting resin is not limited to an epoxy resin, and other thermosetting resins such as an unsaturated polyester resin may be used.

The protective layer 25 is formed on the reinforcing layer 20. The protective layer 25 is made of a glass fiber reinforced resin (GFRP: glass fiber reinforced plastics) which is a composite material of a second thermosetting resin and glass fibers, and has a higher impact resistance than that of the reinforcing layer 20. In the present embodiment, an epoxy resin is used as the second thermosetting resin. However, types and amounts of a curing accelerating agent and a curing agent are adjusted so that the second thermosetting resin has a lower gelling temperature than that of the first thermosetting resin. In the present embodiment, 30 wt % to 40 wt % (weight %) of tetrahydrophthalic anhydride is added as the curing agent, and 1.0 wt % to 2.0 wt % (weight %) of an encapsulated type amine is added as the curing accelerating agent. Types and amounts of the curing agent and the curing accelerating agent are not limited to those in the present embodiment and can be appropriately changed. The second thermosetting resin is not limited to an epoxy resin, and other thermosetting resins such as an unsaturated polyester resin may be used.

The mouthpieces 30 and 40 are attached to two opening ends of the liner 10. The mouthpiece 30 functions as an opening of the high pressure tank 100 and functions as an attachment part for attaching a pipe and a valve to the tank main body. In addition, the mouthpieces 30 and 40 also function as an attachment part for attaching the tank main body to a filament winding device (hereinafter referred to as an FW device) when the reinforcing layer 20 and the protective layer 25 are formed.

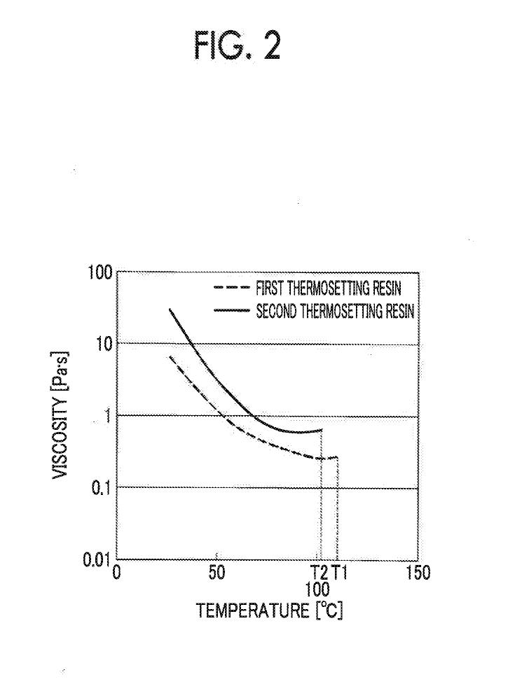

FIG. 2 is a diagram showing temperature-viscosity characteristics of the first thermosetting resin and the second thermosetting resin. FIG. 2 shows a semilogarithmic graph in which the viscosity axis represents a logarithmic scale. A second gelling temperature T2 which is a gelling temperature of the second thermosetting resin is lower than a first gelling temperature T1 which is a gelling temperature of the first thermosetting resin. The gelling temperature refers to a temperature at which the viscosity rapidly changes so that a flowable solution state is brought into a gel state, and is synonymous with the term referred to as a gel transition temperature, a gel dissolution temperature, a phase transition temperature, a sol-gel phase transition temperature, or a gelling point. The temperature-viscosity characteristics shown in FIG. 2 can be obtained using an E type viscometer (for example, RE550H commercially available from Toki Sangyo Co., Ltd.) from viscosity curves obtained by raising the temperature of a high temperature resin in a sol state at a low shear rate at a rate of 7 degrees/min. In addition, using a rheometer (for example, a stress control type rheometer using a cone plate, PhysicaMCR series, commercially available from AntonPaar), they can be obtained from viscosity curves obtained by changing the temperature of a high temperature resin in a sol state at a low shear rate and viscoelasticity curves obtained by measuring a change in temperature of dynamic viscoelasticity. The temperature-viscosity characteristics can be obtained according to various known measurement methods without limitation to the measurement method of the present embodiment. The viscosities of the first thermosetting resin and the second thermosetting resin may be measured according to the same method and the gelling temperature may be determined based on the same criteria.

In the present embodiment, a temperature difference ΔT between the first gelling temperature T1 and the second gelling temperature T2 is about 25° C. When the temperature difference ΔT between the first gelling temperature T1 and the second gelling temperature T2 is 20° C. to 30° C., this is preferable because, in the curing process of the first thermosetting resin and the second thermosetting resin, the second thermosetting resin becomes a gel before fluidity of the first thermosetting resin increases, and thus it is possible to further minimize movement of a gas inherent in the first thermosetting resin to the outer surface of the high pressure tank 100.

### A2. Method of Producing High Pressure Tank

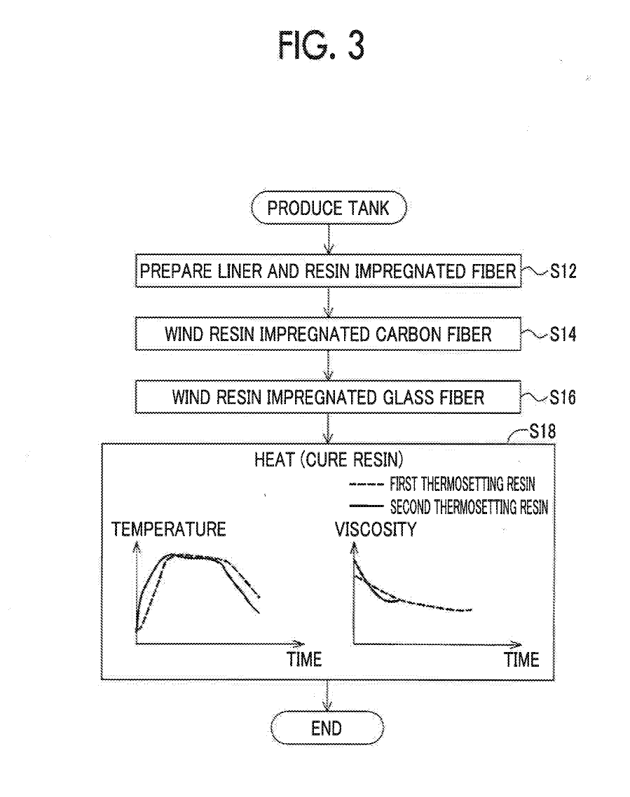

FIG. 3 is a flowchart showing a method of producing the high pressure tank 100. In the present embodiment, the high pressure tank 100 (FIG. 1) is produced according to a filament winding method (FW method). In Step S12, the liner 10 and resin impregnated fibers (resin impregnated carbon fibers and resin impregnated glass fibers) are prepared. Specifically, the tank main body in which the mouthpiece 30 and the mouthpiece 40 are attached to liner 10 is set as a mandrel in an FW device (not shown), and a resin impregnated carbon fiber and resin impregnated glass fiber wound around a bobbin are set at predetermined positions in the FW device. In the present embodiment, a resin impregnated in a carbon fiber is the first thermosetting resin and a resin impregnated in a glass fiber is the second thermosetting resin.

In Step S14, the resin impregnated carbon fiber is wound around the outer surface (including the outer surface of the liner 10) of the tank main body. Specifically, when the FW device starts and the tank main body rotates, the resin impregnated carbon fiber is unwound from the bobbin and the resin impregnated carbon fiber is wound around the outer surface of the tank main body. In this case, hoop winding, helical winding, and the like are appropriately combined to wind the resin impregnated carbon fiber. The tank main body having the outer surface around which the resin impregnated carbon fiber is wound will be referred below to as a “carbon fiber-wound tank main body.” When the resin impregnated carbon fiber is wound a predetermined number of turns, and a resin impregnated carbon fiber layer is formed, the resin impregnated carbon fiber is cut, and a winding terminating end (terminating end) of the resin impregnated carbon fiber is compressively bonded (thermo-compressively bonded) to a winding starting end (starting end) of the resin impregnated glass fiber. The resin impregnated carbon fiber layer includes an uncured first thermosetting resin (before curing) and a carbon fiber. In the present embodiment, the resin impregnated carbon fiber layer is also referred to as a “first thermosetting resin uncured layer.”

In Step S16, on the resin impregnated carbon fiber layer of the carbon fiber-wound tank main body formed in Step S14, in the same manner as in Step S14, a resin impregnated glass fiber is wound and a resin impregnated glass fiber layer is formed. The resin impregnated glass fiber layer includes an uncured second thermosetting resin (before curing) and a glass fiber. In the present embodiment, the resin impregnated glass fiber layer is also referred to as a “second thermosetting resin uncured layer.”

In Step S18, the fiber-wound tank main body in which the resin impregnated carbon fiber layer and the resin impregnated glass fiber layer are formed on the outer circumference of the liner 10 through Steps S14 and S16 is put into a heating furnace, the fiber-wound tank main body is rotated, and heating is performed so that the first thermosetting resin of the resin impregnated carbon fiber layer and the second thermosetting resin of the resin impregnated glass fiber layer reach a curing temperature (for example, about 160° C.). For example, heating is performed for 50 minutes at a setting temperature of 180° C. of the heating furnace, and then heating is performed for 20 minutes at a setting temperature of 160° C.

In the column in Step S18 in FIG. 3, changes of a temperature and a viscosity of the first thermosetting resin and the second thermosetting resin over time are conceptually shown. Since the resin impregnated glass fiber layer including the second thermosetting resin is formed outside relative to the resin impregnated carbon fiber layer including the first thermosetting resin, the second thermosetting resin is heated earlier than the first thermosetting resin. Since the second thermosetting resin has a lower gelling temperature than that of the first thermosetting resin and the second thermosetting resin included in the resin impregnated glass fiber layer is heated earlier than the first thermosetting resin included in the resin impregnated carbon fiber layer, the second thermosetting resin included in the resin impregnated glass fiber layer becomes a gel earlier than the first thermosetting resin included in the resin impregnated carbon fiber layer. Since the resin impregnated carbon fiber layer is an inner layer relative to the resin impregnated glass fiber layer, the first thermosetting resin has a lower heating rate than the second thermosetting resin. Thus, when the second thermosetting resin becomes a gel, the first thermosetting resin has no fluidity or low fluidity. Then, even if the temperature of the first thermosetting resin increases due to heating in the heating furnace and curing reaction heat of the resin, and the fluidity increases, since the second thermosetting resin included in the resin impregnated glass fiber layer has already gelled, it is possible to prevent a gas inherent in the first thermosetting resin and the first thermosetting resin from moving to the outside, and it is possible to prevent the resin impregnated glass fiber layer from being pushed up.

In Step S18, when the first thermosetting resin and the second thermosetting resin are cured, the reinforcing layer 20 and the protective layer 25 are formed. Then, a setting temperature of the heating furnace is lowered, and the high pressure tank 100 is extracted.

### A3. Effects of Embodiment

First, effects of the present embodiment will be described in comparison with a high pressure tank of a comparative example. Like the high pressure tank of the present embodiment, the high pressure tank of the comparative example includes a liner, a reinforcing layer, and a protective layer, and a resin having the same gelling temperature is used. Specifically, as a thermosetting resin for forming the reinforcing layer and the protective layer, the same epoxy resin as in the first thermosetting resin of the present embodiment is used. Like the high pressure tank 100 of the present embodiment, the high pressure tank of the comparative example is formed according to the FW method.

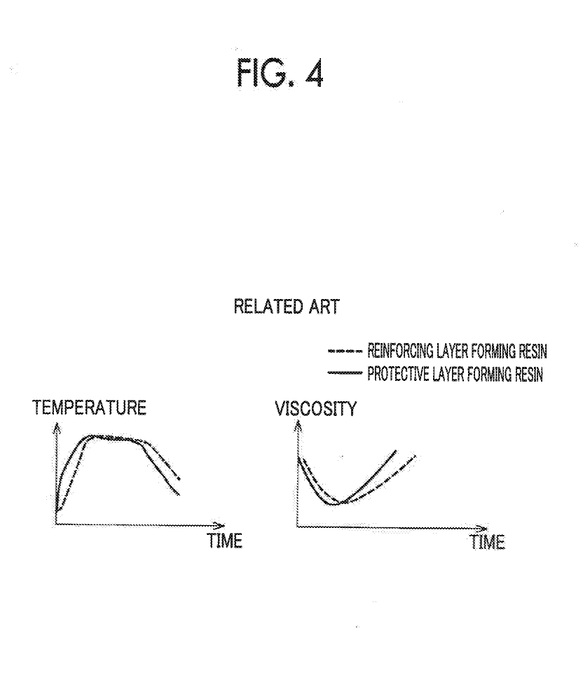

FIG. 4 is an explanatory diagram conceptually showing changes of a temperature and a viscosity of resins over time in the high pressure tank of the comparative example. In FIG. 4, solid lines indicate a resin for forming a protective layer (hereinafter referred to as a “protective layer forming resin”), and dashed lines indicate a resin for forming a reinforcing layer (hereinafter referred to as a “reinforcing layer forming resin”). Since the protective layer forming resin is disposed outside relative to the reinforcing layer forming resin, it is heated earlier than the reinforcing layer forming resin. Since the protective layer forming resin and the reinforcing layer forming resin have the same gelling temperature, when the temperature of the resin increases, the protective layer forming resin becomes a gel earlier than the reinforcing layer forming resin. However, since the protective layer forming resin and the reinforcing layer forming resin are resins having the same properties, when they are heated at the same time, a difference between heating rates of the resins of the protective layer and the reinforcing layer is small. Therefore, before the protective layer forming resin becomes a gel, the viscosity of the reinforcing layer forming resin decreases and the fluidity increases. Since a gas trapped during winding of the resin impregnated fiber, a gas generated in a resin curing process, a gas contained in the resin itself, and the like are inherent in the reinforcing layer forming resin, when the fluidity of the reinforcing layer forming resin increases, and fibers become clogged inside due to tension during winding, an inherent gas escapes (moves) to the outside. In addition, when fibers are clogged inside, the reinforcing layer forming resin also moves outside. In this manner, gases inherent in the reinforcing layer forming resin and the reinforcing layer forming resin move outside to push the protective layer forming resin up, the reinforcing layer forming resin and the inherent gas exude from gaps between fibers (glass fibers in the comparative example) for forming the protective layer, and resin blocks and air bubbles are cured convexly in the surface of the high pressure tank. As a result, the smoothness of the surface of the high pressure tank of the comparative example is impaired. In the high pressure tank of the comparative example, in order to obtain the smoothness for the surface, a process of scraping the surface or the like may be necessary.

On the other hand, according to the high pressure tank 100 of the present embodiment, since a gelling temperature of the second thermosetting resin that forms the protective layer 25 is lower than a gelling temperature of the first thermosetting resin that forms the reinforcing layer 20, before the fluidity of the first thermosetting resin increases, the second thermosetting resin becomes a gel, and a gas inherent in the first thermosetting resin and the first thermosetting resin are prevented from moving outside. Thus, in the surface of the protective layer 25 of the high pressure tank 100, an amount of resin exuded from gaps between glass fibers decreases, and the smoothness of the surface of the high pressure tank 100 is improved.

In the high pressure tank 100 of the present embodiment, a gelling temperature of the second thermosetting resin is about 25° C. lower than a gelling temperature of the first thermosetting resin. When an amount of resin exuded on a tank surface of the high pressure tank 100 of the present embodiment is compared with an amount of resin exuded on a tank surface of the high pressure tank of the comparative example, an amount of resin exuded of the high pressure tank 100 of the present embodiment is reduced to about ⅓ that of the high pressure tank of the comparative example. Here, an amount of resin exuded is obtained by the following method; (1) three-dimensional data including irregularities of the high pressure tank is acquired by a three-dimensional measuring device, (2) in the three-dimensional data acquired in (1), reference data connecting the lowest points of recessed parts is generated, and (3) an amount of resin exuded is calculated by subtracting (2) from (1). According to the high pressure tank 100 of the present embodiment, it is possible to decrease an amount of resin exuded on the tank surface and a process of scraping the surface can be omitted.

### B. Modified Examples

(1) A fluid accommodated in the high pressure tank 100 is not limited to compressed hydrogen described above and may be a high pressure fluid such as compressed nitrogen.

(2) As fibers included in the reinforcing layer 20 and the protective layer 25, various fibers that can form a fiber reinforced resin such as carbon fibers, glass fibers, aramid fibers, Dyneema fibers, Zylon fibers, and boron fibers can be used. Fibers are preferably selected so that the reinforcing layer 20 has a pressure resistance and the protective layer 25 has a higher impact resistance than the reinforcing layer 20. When carbon fibers are used as a fiber of the reinforcing layer 20 and glass fibers or aramid fibers are used as a fiber of the protective layer 25, this is preferable because a reinforcing layer 20 having a high pressure resistance and a protective layer 25 having a higher impact resistance than the reinforcing layer 20 are formed.

(3) The protective layer 25 may be formed using only the second thermosetting resin. In this case, as the protective layer 25, a resin having a desired impact resistance higher than that of the reinforcing layer 20 is preferably selected. When the protective layer 25 is formed using only a resin, according to a known method such as spray application, the resin is sprayed and then heated. Therefore, the protective layer 25 can be formed. For example, in the embodiment, when the protective layer 25 is formed using only the second thermosetting resin, after a carbon fiber in which the first thermosetting resin is impregnated is wound around the liner 10, according to a known method such as spray application, the second thermosetting resin is sprayed and then heated, and the first thermosetting resin and the second thermosetting resin are cured. Therefore, the reinforcing layer 20 and the protective layer 25 can be formed.

(4) While resins (epoxy resins) which are the same type and have different gelling temperatures have been used as the first thermosetting resin and the second thermosetting resin in the above embodiment, the first thermosetting resin and the second thermosetting resin may be thermosetting resins of different types. For example, an unsaturated polyester resin may be used as the first thermosetting resin and an epoxy resin may be used as the second thermosetting resin, or vice versa. Even if such resins of different types are used, according to a difference in temperature increase between the first thermosetting resin and the second thermosetting resin, a decrease in viscosity of the first thermosetting resin is delayed and gelling of the second thermosetting resin is initiated earlier than gelling of the first thermosetting resin. Therefore, when gelling of the second thermosetting resin is initiated, since the first thermosetting resin has no fluidity or has low fluidity, a gas inherent in the first thermosetting resin and the first thermosetting resin can be prevented from moving outside and the smoothness of the tank surface can be improved.

(5) A method of producing the high pressure tank 100 is not limited to that in the embodiment. A heating temperature and a heating time can be appropriately changed according to a resin to be used, a shape of a tank, and the like. For example, it is possible to produce the high pressure tank 100 according to a sheet winding method in which a sheet-like fiber reinforced resin is attached, a resin transfer molding (RIM) method in which a sheet-like fiber is attached and a resin is then impregnated, or the like.

The present technology is not limited to the embodiment and modified examples described above, and can be realized in various configurations without departing from the spirit and scope of the present technology. For example, technical features in embodiment, examples, and modified examples corresponding to technical features in aspects described in the outline section can be appropriately replaced or combined in order to achieve some or all of the effects described above. In addition, when the technical features are not described as essential features in this specification, they can be appropriately omitted.

What is claimed:

1. A high pressure tank comprising:
a liner;
a reinforcing layer which includes a first thermosetting resin and fibers and is formed on the liner; and
a protective layer which includes a second thermosetting resin having a lower gelling temperature than a gelling temperature of the first thermosetting resin and is formed on the reinforcing layer.

2. The high pressure tank according to claim 1, wherein the protective layer includes fibers.

3. A method of producing the high pressure tank according to claim 1, the method comprising:
forming a first thermosetting resin uncured layer on the liner, the first thermosetting resin uncured layer including the first thermosetting resin and the fibers and the first thermosetting resin being uncured in the first thermosetting resin uncured layer;
forming a second thermosetting resin uncured layer including the uncured second thermosetting resin on a surface of the first thermosetting resin uncured layer; and
after forming the second thermosetting resin uncured layer including the uncured second thermosetting resin on the surface of the first thermosetting resin uncured layer, performing heating, curing the first thermosetting resin and the second thermosetting resin, and forming the reinforcing layer and the protective layer.
